(19) United States
(12) Patent Application Publication
(10) Pub. No.: US 2026/0170358 A1
(43) Pub. Date: Jun. 18, 2026

(54) PROBLEM SOLVING METHOD AND SYSTEM BASED ON ABDUCTIVE REASONING FOR ABSTRACTION AND INFERENCE PROBLEMS

(71) Applicant: GWANGJU INSTITUTE OF SCIENCE AND TECHNOLOGY, Gwangju (KR)

(72) Inventors: Seokki LEE, Gwangju (KR); Sundong KIM, Gwangju (KR); Woletemaryam Liyew ABITEW, Gwangju (KR); Mintaek LIM, Gwangju (KR)

(73) Assignee: GWANGJU INSTITUTE OF SCIENCE AND TECHNOLOGY, Gwangju (KR)

(21) Appl. No.: 19/355,537

(22) Filed: Oct. 10, 2025

(30) Foreign Application Priority Data
Dec. 18, 2024 (KR) 10-2024-0190171

(51) Int. Cl. G06N 5/022; G06N 5/04

(52) U.S. Cl. CPC G06N 5/022; G06N 5/04

(57) ABSTRACT

A problem solving method, including: confirming an example problem and a test problem included in an abstraction and inference problem; generating a hierarchical knowledge graph having a plurality of layers by hierarchically analyzing the example problem from a pixel level to a problem level, and specifying core knowledge appearing in the example problem based on the hierarchical knowledge graph; generating the hierarchical knowledge graph having the plurality of layers by hierarchically analyzing the test problem from the pixel level to the problem level, and specifying a candidate component corresponding to the core knowledge based on the hierarchical knowledge graph for the test problem; and generating a solution to the test problem by synthesizing the core knowledge into the candidate component.

### CROSS REFERENCE TO RELATED APPLICATION

The present application claims priority to Korean Patent Application No. 10-2024-0190171, filed Dec. 18, 2024, the entire contents of which are hereby incorporated by reference in its entirety.

### STATEMENT REGARDING PRIOR DISCLOSURES BY THE INVENTOR OR A JOINT INVENTOR

Prior disclosure related to the present application was made by inventors of the present application in journal paper entitled “Abductive Symbolic Solver on Abstraction and Reasoning Corpus” on Aug. 5, 2024. A copy of the journal paper is provided on a concurrently filed Information Disclosure Statement.

### BACKGROUND

### Field

The disclosed embodiments relate to a problem solving method and system based on abductive reasoning for abstraction and inference problems.

### Description of the Related Art

Recently, artificial intelligence has shown impressive problem solving abilities in various fields, but in the categories of mathematical, logical reasoning, and numerical common sense, artificial intelligence agents have shown somewhat lower performance than other fields such as statistical or algebraic reasoning. In particular, tasks for puzzle tests or abstract scenes show the largest performance gap between artificial intelligence models and humans.

Accordingly, research on visual reasoning based on logic and puzzle tests based on visual images is actively being conducted. In particular, an abstraction and reasoning corpus (ARC) is composed of pairs of a plurality of example problems and test problems, and patterns applied to each example problem are formulated, and solutions are composed by applying the corresponding patterns to the next given test problems.

The abstraction and inference problems mainly use a method of formulating a pattern applied to an example problem by specifying objects confirmed from an image in the form of a symbol through domain specific languages (DSLs).

### SUMMARY

The disclosed embodiments are intended to provide a problem solving method and system based on abductive reasoning for abstraction and inference problems capable of establishing a problem solving process similar to that of a human, and deriving accurate solutions to the abstraction and inference problems based on the problem solving process.

In addition, the disclosed embodiments are intended to provide a problem solving method and system based on abductive reasoning for abstraction and inference problems capable of deriving accurate solutions through the abductive reasoning for the abstraction and inference problems.

There is provided a problem solving method including: confirming an example problem and a test problem included in an abstraction and inference problem; generating a hierarchical knowledge graph having a plurality of layers by hierarchically analyzing the example problem from a pixel level to a problem level, and specifying core knowledge appearing in the example problem based on the hierarchical knowledge graph; generating the hierarchical knowledge graph having the plurality of layers by hierarchically analyzing the test problem from the pixel level to the problem level, and specifying a candidate component corresponding to the core knowledge based on the hierarchical knowledge graph for the test problem; and generating a solution to the test problem by synthesizing the core knowledge into the candidate component.

There is provided a problem solving system including: a storage unit storing an example problem and a test problem included in an abstraction and inference problem; and a control unit analyzing the example problem and generating a solution corresponding to the test problem, in which the control unit generates a hierarchical knowledge graph having a plurality of layers by hierarchically analyzing the example problem from a pixel level to a problem level, specifies core knowledge appearing in the example problem based on the hierarchical knowledge graph, generates a hierarchical knowledge graph having a plurality of layers by hierarchically analyzing the test problem from the pixel level to the problem level, specifies a candidate component corresponding to the core knowledge based on the hierarchical knowledge graph for the test problem, and synthesizes the core knowledge into the candidate component to generate a solution to the test problem.

There is provided a program stored in a computer-readable recording medium, executed by one or more processes in an electronic device, in which the program includes instructions to perform the following: confirming an example problem and a test problem included in an abstraction and inference problem; generating a hierarchical knowledge graph having a plurality of layers by hierarchically analyzing the example problem from a pixel level to a problem level, and specifying core knowledge appearing in the example problem based on the hierarchical knowledge graph; generating the hierarchical knowledge graph having the plurality of layers by hierarchically analyzing the test problem from the pixel level to the problem level, and specifying a candidate component corresponding to the core knowledge based on the hierarchical knowledge graph for the test problem; and generating a solution to the test problem by synthesizing the core knowledge into the candidate component.

According to the problem solving method and system based on abductive reasoning for abstraction and inference problems according to various embodiments of the present invention, generating the hierarchical knowledge graph having the hierarchical symbolic nodes from the abstraction and inference problems, specifying the core knowledge based on the hierarchical knowledge graph of the example problem, and generate the solution to the test problem by applying the specified core knowledge to the hierarchical knowledge graph of the test problem, it is possible to establish the problem solving process similar to that of the human, and derive the accurate solutions to the abstraction and inference problems based on the established problem solving process.

In addition, according to the problem solving method and system based on abductive reasoning for abstraction and inference problems according to various embodiments of the present invention, solving the test problem based on the recurring patterns by sequentially observing the plurality of example problems corresponding to the abstraction and inference problems, it is possible to derive the accurate solutions through the abductive reasoning for the abstraction and inference problems.

### BRIEF DESCRIPTION OF THE DRAWINGS

FIGS. 1 and 2 illustrate an embodiment of a problem solving process according to a problem solving system.

FIG. 3 illustrates an embodiment of abstraction and inference problems.

FIG. 4 illustrates an embodiment of a hierarchical knowledge graph.

FIGS. 5 and 6 illustrate an embodiment of a domain specific language used in the hierarchical knowledge graph.

FIG. 7 illustrates a problem solving system according to the present invention.

FIG. 8 is a flowchart illustrating a problem solving method according to the present invention.

FIG. 9 is a flowchart illustrating an embodiment of generating a hierarchical knowledge graph for an example problem.

FIG. 10 is a flowchart illustrating an embodiment of specifying core knowledge.

FIG. 11 is a flowchart illustrating an embodiment of specifying a candidate component.

FIG. 12 is a flowchart illustrating an embodiment of generating a solution to a test problem.

FIG. 13 is a block diagram illustrating an embodiment of a computing system in which the present invention may be implemented.

FIGS. 14 and 15 are block diagrams illustrating an embodiment of a computing device according to the present invention.

### DETAILED DESCRIPTION

Hereafter, embodiments described in the present specification will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, in describing the embodiments disclosed in the present specification, when it is determined that a detailed description for the known art related to the present invention may obscure the gist of the embodiments described in the present specification, the detailed description will be omitted. Further, it should be understood that the accompanying drawings are provided only in order to allow the embodiments described in the present specification to be easily understood, and the spirit of the present invention is not limited by the accompanying drawings, but includes all the modifications, equivalents, and substitutions included in the spirit and the scope of the present invention.

Terms including ordinal numbers such as “first,” “second,” etc., may be used to describe various components, but the components are not to be construed as being limited to the terms. The terms are only used to differentiate one component from other components.

It is to be understood that when a component is referred to as being “connected to” or “coupled to” another component, it may be connected directly to or coupled directly to another element or be connected to or coupled to another element, having other components intervening therebetween. On the other hand, it should be understood that when one component is referred to as being “connected directly to” or “coupled directly to” another component, it may be connected to or coupled to another component without other components interposed therebetween.

Singular expressions are intended to include plural expressions unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

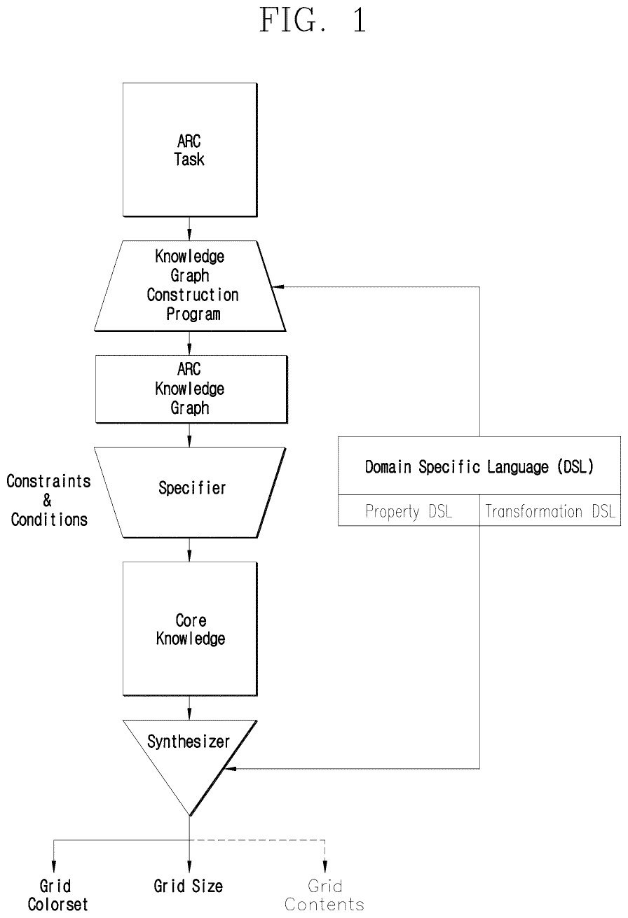

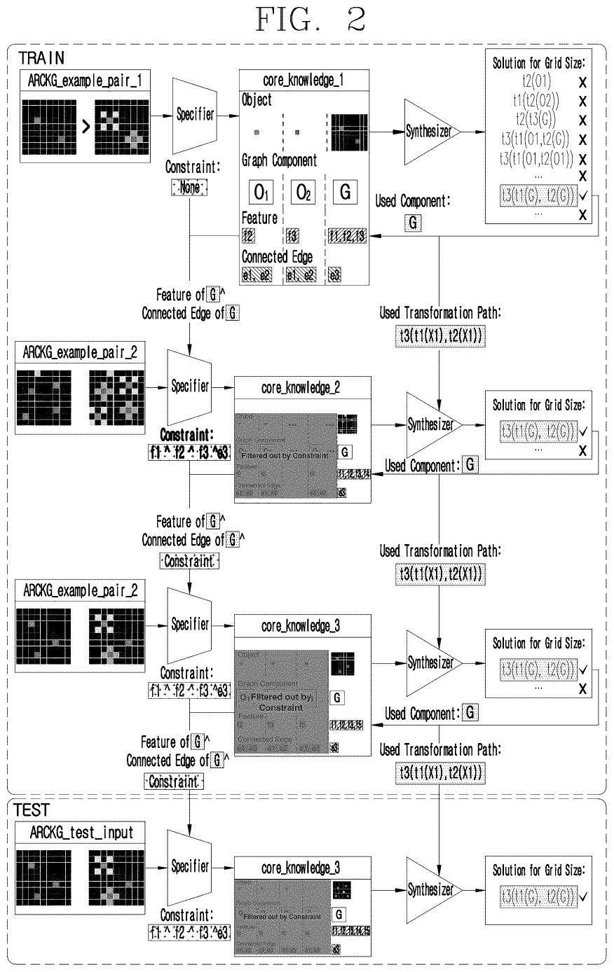

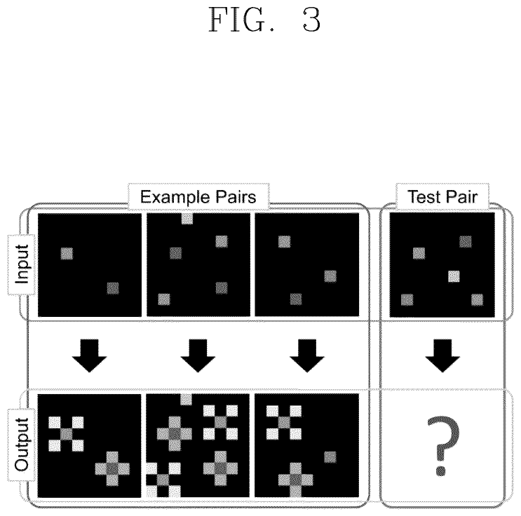

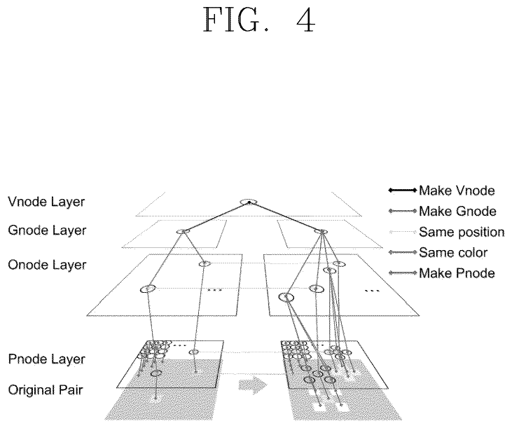

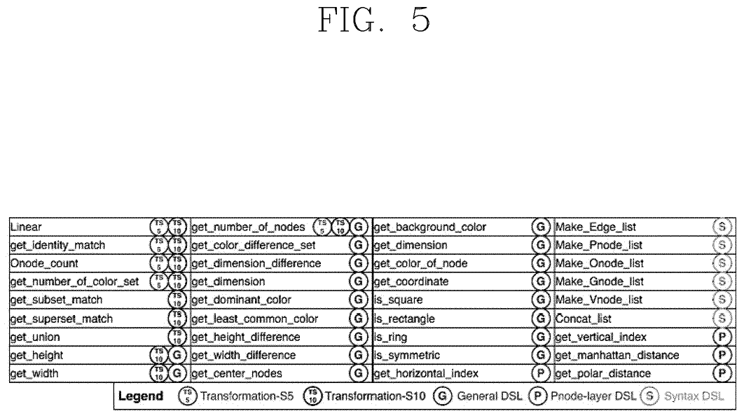

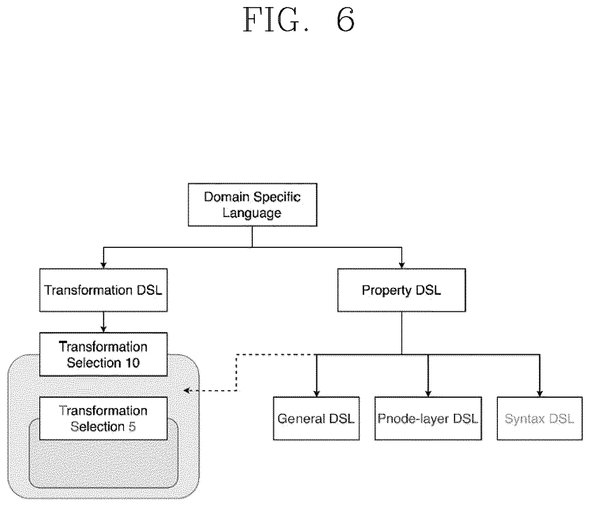

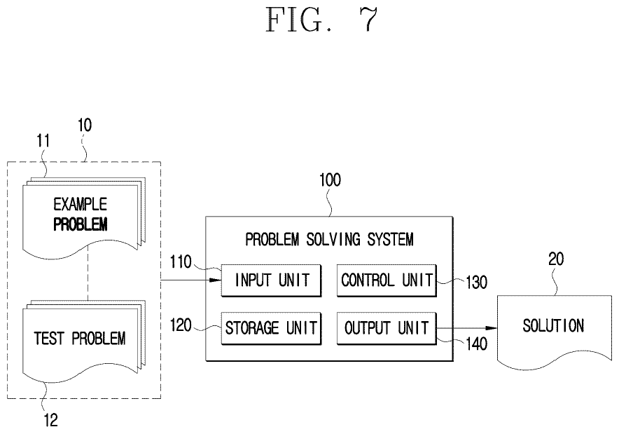

FIGS. 1 and 2 illustrate an embodiment of a problem solving process according to a problem solving system. FIG. 3 illustrates an embodiment of abstraction and inference problems. FIG. 4 illustrates an embodiment of a hierarchical knowledge graph. FIGS. 5 and 6 illustrate an embodiment of a domain specific language used in the hierarchical knowledge graph. FIG. 7 illustrates a problem solving system according to the present invention.

Referring to FIGS. 1 and 2, a problem solving system 100 may generate a hierarchical knowledge graph (knowledge graph) for an abstraction and reasoning corpus (ARC), specify core knowledge in the hierarchical knowledge graph for an example problem, specify candidate components in the hierarchical knowledge graph for a test problem, and synthesize the candidate components and the core knowledge to generate a solution corresponding to the test problem.

In this regard, as illustrated in FIG. 3, the abstraction and inference problems may include a plurality of example problems (i.e., example pairs) and test problems (i.e., test pairs). That is, the abstraction and inference problems may be configured to train a pattern of a recurring problem through the abstraction of the plurality of example problems and solve the test problem based on the trained pattern.

In this case, the example problem may include a pair of example input data (e.g., input) and example output data (e.g., output). In this case, the example input data may represent a problem provided according to the abstraction and inference problems. The example input data may be generated in the form that an object having a predetermined shape is placed at any location on a grid of a preset size, or a predetermined color is placed at any pixel. The example input data may be implemented in the form of an array in which a color is determined by location, or in the form of an image in which any color is determined for each of the plurality of pixels.

In addition, the example output data is a solution to the example input data, and may be implemented in forms such as a change in a location of a specific object derived from the example input data, a transformation into an object of a different shape, or a change in a color of a specific pixel to a different color based on the example input data. Such example output data is provided to correspond to the example input data, and may be implemented in the form of an array in which colors are determined by location, or in the form of an image in which any color is determined for each of the plurality of pixels.

In addition, the test problem may include test input data (e.g., input), and the test input data may be provided to correspond to the example input data of the example problem. That is, the test input data is a problem provided according to the abstraction and inference problems, and may be generated in the form that an object having a predetermined shape is at any location on a grid of a preset size, or that a predetermined color is placed at any pixel. The test input data may be implemented in the form of an array in which a color is determined by location, or in the form of an image in which any color is determined for each of the plurality of pixels.

The hierarchical knowledge graph may hierarchically represent the analysis results by analyzing the example problem or the test problem, as illustrated in FIG. 4. The hierarchical knowledge graph may be a hierarchical analysis from a pixel level to a problem level of each problem.

In this case, each of the plurality of layers included in the hierarchical knowledge graph may include one or more nodes to represent information on a lower layer. That is, the node may include information on a node generated in the lower layer. According to an embodiment, the node may be understood as including the node generated in the lower layer.

For example, the hierarchical knowledge graph may be generated in four layers, from a first layer to a fourth layer. In this case, the first layer may include a plurality of first nodes, the second layer may include one or more second nodes, the third layer may include a third node, and the fourth layer may include a fourth node.

Accordingly, the first node may include information (e.g., color or location) on each problem in the pixel level, the second node may represent a set of pixels having the same properties among the plurality of first nodes, the third node may include one or more second nodes, and the fourth node may include one or more third nodes.

In this case, according to an embodiment, the first node may be named Pnode, the second node may be named Onode, the third node may be named Gnode, and the fourth node may be named Vnode. In this case, the first layer may be named a Pnode layer, the second layer may be named an Onode layer, the third layer may be named a Gnode layer, and the fourth layer may be named a Vnode layer.

In this regard, the hierarchical knowledge graph may be independently generated for each example problem or test problem. That is, when the abstraction and inference problems include the plurality of example problems and a single test problem, the hierarchical knowledge graph may be generated for each of the plurality of example problems and test problems.

In addition, in the hierarchical knowledge graph, each of the first layer, the second layer, and the third layer may be independently generated for the example input data and the example output data included in the example problem, and the fourth layer may be generated to represent a relationship between the example input data and the example output data.

That is, the problem solving system 100 may generate the plurality of first nodes based on information on specific example input data in the pixel level, generate one or more second nodes based on the plurality of first nodes for the corresponding example input data, and generate the third node based on one or more second nodes for the corresponding example input data.

In addition, the problem solving system 100 may generate the plurality of first nodes based on information on specific example output data in the pixel level, generate one or more second nodes based on the plurality of first nodes for the corresponding example output data, and generate the third node based on one or more second nodes for the corresponding example output data.

In this case, the problem solving system 100 may generate an edge based on a relationship between nodes included in each layer for the example input data and the example output data included in a specific example problem. Here, the edge may represent a connection relationship between nodes having the same property in an equivalent layer.

In addition, the problem solving system 100 may generate the fourth node based on the third node of the example input data included in the specific example problem and the third node for the example output data included in the corresponding example problem.

Meanwhile, the core knowledge may represent a series of patterns that commonly (or repeatedly) appear in the plurality of example problems included in the abstraction and inference problems. The core knowledge may be specified by comparing the plurality of example problems by layer based on the hierarchical knowledge graph. That is, the core knowledge may include one or more nodes that are specified based on the comparison result between the hierarchical knowledge graphs corresponding to the plurality of example problems.

In addition, the candidate component may represent a pattern corresponding to the core knowledge among predetermined patterns that appear in the test problem. The candidate components may be specified in the hierarchical knowledge graph of the test problem based on the core knowledge specified based on the plurality of example problems. That is, the candidate components may include one or more nodes specified based on the comparison result between the core knowledge specified based on the plurality of example problems and the hierarchical knowledge graph corresponding to the test problem included in the same abstraction and inference problems as the plurality of example problems.

Meanwhile, the solution to the test problem may be obtained by training the pattern appearing from the example problem and applying the trained pattern to the test problem, and output by training the example problem according to the abstraction and inference problems and performing the inference on the test problem based on the training results.

The solution may be obtained by synthesizing the core knowledge in the candidate component. To this end, the problem solving system 100 may generate the solution by specifying the core knowledge based on the hierarchical knowledge graph for the plurality of example problems, specifying the candidate components corresponding to the core knowledge from the hierarchical knowledge graph for the test problem, and synthesizing the transformation relationship according to the core knowledge specified before the candidate component.

Here, the transformation relationship may represent a relationship in which a plurality of nodes according to the example input data are transformed into a plurality of nodes according to the example output data, and may be estimated from specific core knowledge based on the hierarchical knowledge graph for the plurality of example problems. Accordingly, the transformation relationship may include a command for transforming a node corresponding to the example input data into a node corresponding to the example output data. For example, the command according to the transformation relationship may include a command for generating a node, a command for changing a location or color of the node, etc.

In this regard, the node or the transformation relationship included in the hierarchical knowledge graph may be implemented based on domain specific languages (DSLs), as illustrated in FIG. 5. The domain specific languages may include data representing the properties of the nodes included in the hierarchical knowledge graph (e.g., property data) and data (e.g., transformation data) representing the command according to the transformation relationship. In this case, referring to FIG. 6, the relationship between the property data and the transformation data that are implemented in the domain specific languages may be confirmed.

Therefore, the problem solving system 100 may generate the hierarchical knowledge graph for the plurality of example problems and test problems using the domain specific languages implemented to solve the abstraction and inference problems based on the hierarchical knowledge graph, specify the core knowledge and the candidate components based on the hierarchical knowledge graph, and generate the solution corresponding to the test problem by synthesizing the candidate components and the core knowledge.

To this end, referring to FIG. 7, the problem solving system 100 may include an input unit 110, a storage unit 120, a control unit 130, and an output unit 140.

Information required for the operation of the problem solving system 100 according to the present invention may be input into the input unit 110. To this end, the input unit 110 may be connected to a separate input device, a server, an external storage device, etc., via a wireless or wired network.

Therefore, the input unit 110 may receive an example problem 11 and a test problem 12 included in an abstraction and inference problem 10 from a separate input device, a server, an external storage device, etc. In addition, the input unit 110 may receive a user command for generating the hierarchical knowledge graph for each of the example problem 11 and the test problem 12, or generating a solution 20 corresponding to the test problem 12 based on the hierarchical knowledge graph.

In addition, the storage unit 120 may store instructions and information necessary for the operation of the problem solving system 100 according to the present invention. For example, the storage unit 120 may store the example problem 11 and the test problem 12 included in the abstraction and inference problem 10.

In addition, the storage unit 120 may store the hierarchical knowledge graph generated for the example problem 11 and the test problem 12, store the core knowledge and the candidate components specified based on the hierarchical knowledge graph, and store the solution 20 generated based on the core knowledge and the candidate components.

The control unit 130 may control the overall operation of the problem solving system 100 according to the present invention. That is, the control unit 130 may generate the hierarchical knowledge graph for the example problem 11 and the test problem 12, specify the core knowledge and the candidate components based on the hierarchical knowledge graph, and synthesize the core knowledge and the candidate components to generate the solution 20 corresponding to the test problem 12.

Specifically, the control unit 130 may confirm the example problem 11 and the test problem 12 included in the abstraction and inference problems 10. That is, the control unit 130 may confirm the plurality of example problem 11 and one or more test problems 12 included in the abstraction and inference problem 10. In this case, each of the plurality of example problem 11 may include the pair of the example input data and the example output data, and the test problem 12 may include the test input data.

Accordingly, the control unit 130 may generate the hierarchical knowledge graph having the plurality of layers by hierarchically analyzing the example problem 11 from the pixel level to the problem level, and specify the core knowledge appearing in the example problem 11 based on the hierarchical knowledge graph.

To this end, the control unit 130 may generate the first layer through the analysis of the example problem 11 in the pixel level, analyze the properties of the plurality of first nodes generated in the first layer according to the analysis result in the pixel level to generate the second layer, generate the third layer based on one or more second nodes generated in the second layer according to the analysis results of the properties, and generate the fourth layer based on the third layer generated for each of the example input data and the example output data of the example problem 11.

In this case, the control unit 130 may generate, in the first layer, the plurality of first nodes for each of the example input data and the example output data included in the example problem 11 in the pixel level, compare the properties of each of the plurality of first nodes in the example input data and the plurality of first nodes in the example output data, and generate an edge connecting the first node in the example input data and the first node in the example output data based on the comparison result.

In addition, the control unit 130 may specify one or more first nodes having the same properties in each of the first layer for the example input data and the first layer for the example output data, generate, in the second layer, the second node including one or more previously specified first nodes, compare the second node in the example input data and the second node in the example output data, and generate an edge connecting the second node in the example input data and the second node in the example output data based on the comparison result.

In addition, the control unit 130 may specify one or more second nodes generated in each of the second layer for the example input data and the second layer for the example output data, and generate, in the third layer, the third node including one or more previously specified second nodes.

In addition, the control unit 130 may specify the third nodes generated in each of the third layer for the example input data and the third layer for the example output data, and generate, in the fourth layer, the fourth node including the third node in the previously specified example input data and the third node in the example output data.

Accordingly, the control unit 130 may compare the hierarchical knowledge graphs generated for each of the plurality of example problem 11 included in the abstraction and inference problem 10 by layer to specify one or more nodes having the same properties as the core knowledge.

Meanwhile, the control unit 130 may generate the hierarchical knowledge graph having the plurality of layers by hierarchically analyzing the test problem 12 from the pixel level to the problem level, and specify the candidate components corresponding to the core knowledge based on the hierarchical knowledge graph for the test problem 12.

To this end, the control unit 130 may generate the first layer through the analysis of the test problem 12 in the pixel level, generate the second layer by analyzing the properties of the plurality of first nodes generated in the first layer according to the analysis result in the pixel level, generate the third layer based on one or more second nodes generated in the second layer according to the analysis results of the properties, and generate the fourth layer based on the third layer generated for the test input data of the test problem 12.

In this case, the control unit 130 may generate, in the first layer, the plurality of first nodes in the pixel level for the test input data included in the test problem 12.

In addition, the control unit 130 may specify one or more first nodes having the same properties in the first layer for the test input data, and generate, in the second layer, the second node including one or more previously specified first nodes.

In addition, the control unit 130 may specify one or more second nodes generated in the second layer for the test input data, generate, in the third layer, the third node including one or more previously specified second nodes, specify the third node generated in the third layer for the test input data, and generate, in the fourth layer, the fourth node including the third node in the previously specified test input data.

Accordingly, the control unit 130 may specify the candidate component corresponding to the core knowledge in the hierarchical knowledge graph generated for the test problem 12 based on the core knowledge specified based on the plurality of example problem 11 included in the abstraction and inference problem 10.

Furthermore, the control unit 130 may generate the solution 20 to the test problem 12 by synthesizing the core knowledge into the candidate components. To this end, the control unit 130 may specify the transformation relationship from the example input data to the example output data based on the core knowledge, and generate the solution 20 to the test problem 12 by applying the previously specified transformation relationship from the hierarchical knowledge graph for the test problem 12 to the specified candidate components.

The output unit 140 may output the information generated by the operation of the problem solving system 100 according to the present invention. To this end, the output unit 140 may be connected to a separate visual output device, a server, an external storage device, etc., via a wireless or wired network.

Accordingly, the output unit 140 may output the example problem 11 and the test problem 12 included in the abstraction and inference problem 10 and the solution 20 so that the user may visually confirm the example problem 11 and the test problem 12, the solution 20, etc., through the separate output device, the server, or the external storage device. According to the embodiment, the output unit 140 may also transmit the example problem 11 and the test problem 12 included in the abstraction and inference problem 10, the solution 20, etc., to another device.

Based on the configuration of the problem solving system 100 described above, the problem solving method will be described in more detail below.

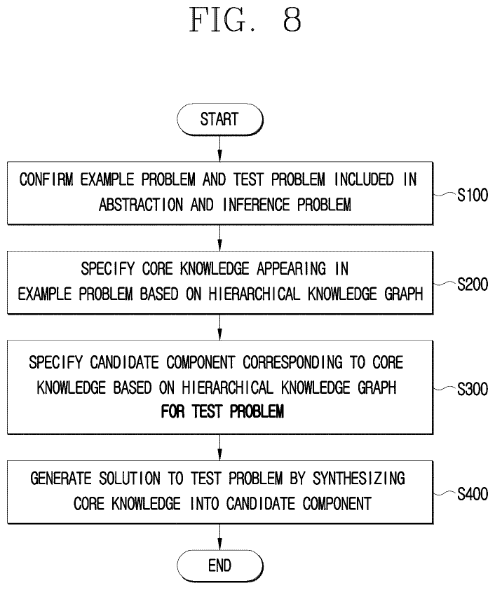

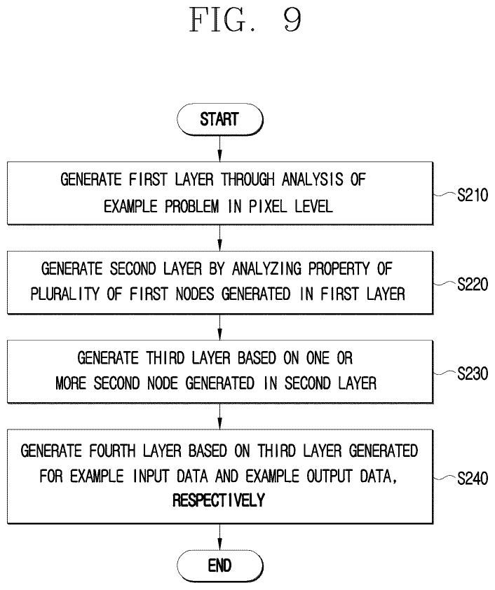

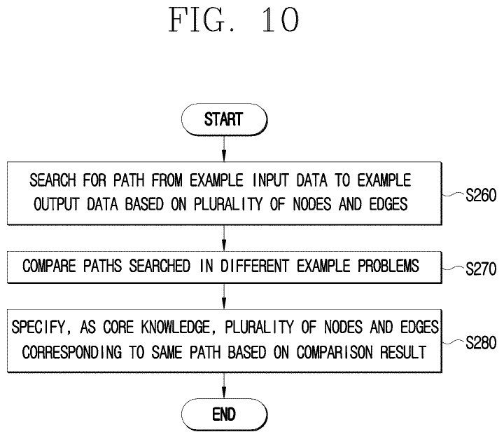

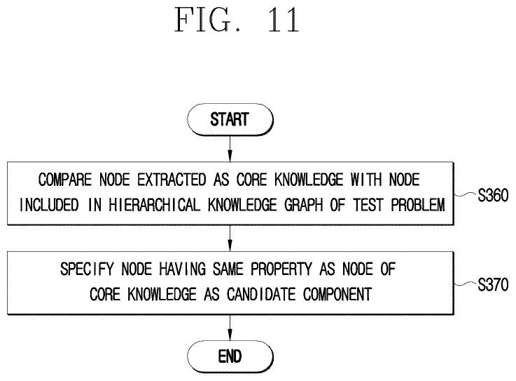

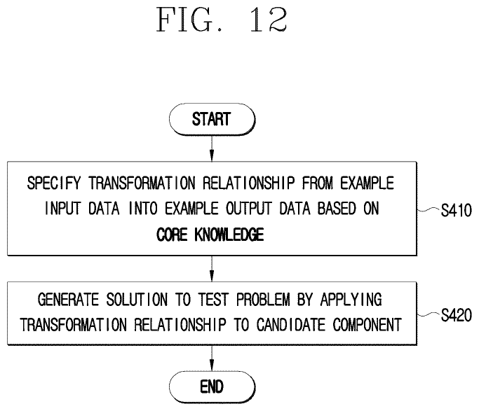

FIG. 8 is a flowchart illustrating the problem solving method according to the present invention. FIG. 9 is a flowchart illustrating an embodiment of generating the hierarchical knowledge graph for the example problem. FIG. 10 is a flowchart illustrating an embodiment of specifying the core knowledge. FIG. 11 is a flowchart illustrating an embodiment of specifying the candidate components. FIG. 12 is a flowchart illustrating an embodiment of generating the solution to the test problem.

Referring to FIG. 8, the problem solving system 100 according to the present invention may confirm the example problem and the test problems included in the abstraction and inference problems (S100).

Specifically, the problem solving system 100 may confirm the plurality of example problems included in the abstraction and inference problems and one or more test problems. In this case, each of the plurality of example problems may include the pair of the example input data and the example output data, and the test problem may include the test input data.

For example, the problem solving system 100 may confirm the abstraction and inference problems including three example problems and one test problem.

In this case, each example problem may include the example input data in the form that pixels of different colors are arranged at any location on a grid of a preset size, and the example output data corresponding to the example input data, in the form that pixels of a specific color are arranged according to a predetermined pattern at any pixels adjacent to pixels of different colors.

In addition, the test problem may include the test input data in the form that pixels of different colors are arranged at any location on the grid of the preset size, and the test input data may be prepared to correspond to the example input data.

For another example, the problem solving system 100 may confirm the abstraction and inference problems including the plurality of example problems and one or more test problems. In this case, each example problem may include the example input data in the form that a predetermined object is arranged at any location on the grid of the preset size, and the example output data corresponding to the example input data, in which the location or shape of the predetermined object is modified. Here, the predetermined object may be one or more of the plurality of objects. In this case, the plurality of objects may have at least one of different shapes and colors determined for each object.

In addition, the test problem may include the test input data in the form that a predetermined object is arranged at any location on the grid of the preset size, and the test input data may be prepared to correspond to the example input data.

The problem solving system 100 according to the present invention may generate the hierarchical knowledge graph having the plurality of layers by hierarchically analyzing the example problem from the pixel level to the problem level, and specify the core knowledge appearing in the example problem based on the hierarchical knowledge graph (S200).

Specifically, as illustrated in FIG. 9, the problem solving system 100 may generate the first layer through the analysis of the example problem in the pixel level (S210), generate the second layer by analyzing the properties of the plurality of first nodes generated in the first layer according to the analysis results in the pixel level (S220), generate the third layer based on one or more second nodes generated in the second layer according to the analysis results of the properties (S230), and generate the fourth layer based on the third layer generated for each of the example input data and the example output data of the example problem (S240).

To this end, the problem solving system 100 may generate, in the first layer, the plurality of first nodes in the pixel level for each of the example input data and the example output data included in the example problem, compare the properties of each of the plurality of first nodes in the example input data and the plurality of first nodes in the example output data, and generate the edge connecting the first node in the example input data and the first node in the example output data based on the comparison result.

For example, the problem solving system 100 may generate, in the first layer, the plurality of first nodes corresponding to the plurality of pixels of the example input data. In this case, each of the plurality of first nodes may include color values or location values corresponding to the plurality of pixels, so the first layer of the example input data may be generated to include the plurality of first nodes.

In addition, the problem solving system 100 may generate, in the first layer, the plurality of first nodes corresponding to the plurality of pixels of the example output data. In this case, each of the plurality of first nodes may include the color values or the location values corresponding to the plurality of pixels, so the first layer of the example output data may be generated to include the plurality of first nodes.

That is, the problem solving system 100 may generate the first layer for the example input data and the first layer for the example output data, respectively. Accordingly, the problem solving system 100 may compare, in the first layer, the color values or the location values of each of the plurality of first nodes included in the first layer for the example input data and each of the plurality of first nodes included in the first layer for the example output data, and connect the first node of the example input data having the same color value or location value and the first node of the example output data with the edge based on the comparison result.

In this regard, the problem solving system 100 may generate the first layer for each of the plurality of example problems included in the abstraction and inference problems, as described above. In this case, the first layer for each of the plurality of example problems may be generated independently of each other.

Furthermore, the problem solving system 100 may specify one or more first nodes having the same properties in each of the first layer for the example input data and the first layer for the example output data, generate, in the second layer, the second node including one or more previously specified first nodes, compare the second node in the example input data and the second node in the example output data, and generate an edge connecting the second node in the example input data and the second node in the example output data based on the comparison result.

For example, the problem solving system 100 may specify one or more first nodes having the same color value in the first layer for the example input data. Accordingly, the problem solving system 100 may generate, in the second layer of the example input data, the second node including the one or more previously specified first nodes. In this case, the second node may include the color values or the location values for one or more previously specified first nodes, and the problem solving system 100 may configure the second layer so that the first nodes having different color values are included in different second nodes.

In addition, the problem solving system 100 may specify one or more first nodes having the same color value in the first layer for the example output data. Accordingly, the problem solving system 100 may generate, in the second layer of the example output data, the second node including the one or more previously specified first nodes. In this case, the problem solving system 100 may configure the second layer so that the first nodes having different color values are included in different second nodes, so the second node may include information such as the color values, the location values, size values (e.g., the number of first nodes), and center nodes for the one or more previously specified first nodes.

That is, the problem solving system 100 may generate the second layer for the example input data and the second layer for the example output data, respectively. Accordingly, the problem solving system 100 may compare, in the second layer, the color values of each of the plurality of second nodes included in the second layer for the example input data and each of the plurality of second nodes included in the second layer for the example output data, and connect the second node of the example input data having the same color value and the second node of the example output data with the edge based on the comparison result.

In this regard, the problem solving system 100 may generate the second layer for each of the plurality of example problems included in the abstraction and inference problems, as described above. In this case, the second layer for each of the plurality of example problems may be generated independently of each other.

Furthermore, the problem solving system 100 may specify one or more second nodes generated in each of the second layer for the example input data and the second layer for the example output data, and generate, in the third layer, the third node including one or more previously specified second nodes.

For example, the problem solving system 100 may specify one or more second nodes generated in the second layer for the example input data, and may generate, in the third layer, the third node including one or more previously specified second nodes.

In addition, the problem solving system 100 may specify one or more second nodes generated in the second layer for the example output data, and generate the third node including one or more previously specified second nodes in the third layer, so the third node may include the information such as the color value, the size value (e.g., the number of first nodes), and the number of objects (e.g., the number of second nodes) for the previously specified second nodes.

That is, the problem solving system 100 may generate the third layer for the example input data and the third layer for the example output data, respectively. In this regard, the problem solving system 100 may generate the third layer for each of the plurality of example problems included in the abstraction and inference problems, as described above. In this case, the third layer for each of the plurality of example problems may be generated independently of each other.

Furthermore, the problem solving system 100 may specify the third nodes generated in each of the third layer for the example input data and the third layer for the example output data, and generate, in the fourth layer, the fourth node including the third node in the previously specified example input data and the third node in the example output data.

For example, the problem solving system 100 may specify the third node generated in the third layer for the example input data, specify the third node generated in the third layer for the example output data, and generate, in the fourth layer, the fourth node including the third node in the previously specified example input data and the third node in the example output data.

In this regard, the problem solving system 100 may generate the fourth layer for each of the plurality of example problems included in the abstraction and inference problems, as described above. In this case, the fourth layer for each of the plurality of example problems may be generated independently of each other.

Furthermore, the problem solving system 100 may compare the hierarchical knowledge graphs generated for each of the plurality of example problems included in the abstraction and inference problems by layer to specify one or more nodes having the same properties as the core knowledge.

For example, the problem solving system 100 may compare nodes (e.g., the second node and/or the third node) generated for one of the plurality of example problems included in the abstraction and inference problems with nodes (e.g., the second node and/or the third node) generated for another example problem.

Accordingly, the problem solving system 100 may specify nodes (e.g., the second node and/or the third node) having the same properties based on the comparison results. That is, the problem solving system 100 may filter out nodes (e.g., the second node and/or the third node) in which the same properties are not confirmed.

In addition, the problem solving system 100 may compare the nodes (e.g., the second node and/or the third node) generated for another example problem among the plurality of example problems with the nodes (e.g., the second node and/or the third node) specified based on the comparison result described above, and specify the nodes (e.g., the second node and/or the third node) having the same properties based on the comparison result.

That is, the problem solving system 100 may sequentially compare the plurality of example problems included in the abstraction and inference problems and specify the nodes (e.g., the second node and/or the third node) having the same properties in the plurality of example problems as the core knowledge.

For another example, the problem solving system 100 may generate the core knowledge by generating a path connecting each of the plurality of nodes in the hierarchical knowledge graph corresponding to each of the plurality of example problems.

In this case, as illustrated in FIG. 10, the problem solving system 100 may search for a path from the example input data to the example output data based on the plurality of nodes and edges belonging to the hierarchical knowledge graph for the specific example problem (S260), compare paths searched in different example problems (S270), and specify the plurality of nodes and edges corresponding to the same path as the core knowledge based on the comparison result (S280).

Here, when, in the process of searching for a path based on the hierarchical knowledge graph, the path reaches a node corresponding to a layer (e.g., the second layer) having a predetermined depth, the problem solving system 100 may output the corresponding path.

Referring back to FIG. 8, the problem solving system 100 according to the present invention may generate the hierarchical knowledge graph having the plurality of layers by hierarchically analyzing the test problem from the pixel level to the problem level, and specify the candidate components corresponding to the core knowledge based on the hierarchical knowledge graph for the test problem (S300).

Specifically, the problem solving system 100 may generate the first layer through the analysis of the test problem in the pixel level, generate the second layer by analyzing the properties of the plurality of first nodes generated in the first layer according to the analysis result in the pixel level, generate the third layer based on one or more second nodes generated in the second layer according to the analysis results of the properties, and generate the fourth layer based on the third layer generated for the test input data of the test problem.

To this end, the problem solving system 100 may generate, in the first layer, the plurality of first nodes for the test input data included in the test problem in the pixel level.

For example, the problem solving system 100 may generate, in the first layer, the plurality of first nodes corresponding to the plurality of pixels of the test input data. In this case, each of the plurality of first nodes may include the color values or the location values corresponding to the plurality of pixels, so the first layer of the test input data may be generated to include the plurality of first nodes.

Furthermore, the problem solving system 100 may specify, in the first layer for the test input data, one or more first nodes having the same properties, and generate, in the second layer, the second node including one or more previously specified first nodes.

For example, the problem solving system 100 may specify one or more first nodes having the same color value in the first layer for the test input data. Accordingly, the problem solving system 100 may generate, in the second layer of the test input data, the second node including the one or more previously specified first nodes. In this case, the second node may include the color values or the location values for one or more previously specified first nodes, and the problem solving system 100 may configure the second layer so that the first nodes having different color values are included in different second nodes.

Furthermore, the problem solving system 100 may specify one or more second nodes generated in the second layer for the test input data, and may generate, in the third layer, the third node including one or more previously specified second nodes.

In addition, the problem solving system 100 may specify the third node generated in the third layer for the test input data, and may generate, in the fourth layer, the fourth node including the third node in the previously specified test input data.

Furthermore, the problem solving system 100 may specify the candidate components corresponding to the core knowledge in the hierarchical knowledge graph generated for the test problem based on the core knowledge specified based on the plurality of example problems included in the abstraction and inference problems.

Referring to FIG. 11, for example, the problem solving system 100 may compare the nodes (e.g., the second node and/or the third node) extracted as the core knowledge by being confirmed as having the same properties based on the comparison of the plurality of example problems with the nodes (e.g., the second node and/or the third node) included in the hierarchical knowledge graph of the test problem (S360), and based on the comparison result, specify, as the candidate components, the nodes (e.g., the second node and/or the third node) having the same properties as the nodes (e.g., the second node and/or the third node) of the core knowledge among the nodes (e.g., the second node and/or the third node) included in the hierarchical knowledge graph of the test problem (S370).

Here, the problem solving system 100 may determine that the properties are the same when the color or location of the first node included in the second node is the same. As a result, the problem solving system 100 may specify the candidate components corresponding to the core knowledge in the hierarchical knowledge graph of the test problem based on the core knowledge specified as having the same properties in the hierarchical knowledge graph of the plurality of example problems.

For another example, the problem solving system 100 may compare the nodes (e.g., the second node and/or the third node) corresponding to the example input data among the core knowledge specified based on the plurality of example problems with the nodes (e.g., the second node and/or the third node) corresponding to the test input data of the test problem, and specify, as the candidate components, the nodes (e.g., the second node and/or the third node) of the test input data having the same properties as the nodes (e.g., the second node and/or the third node) of the example input data based on the comparison result.

Referring back to FIG. 8, the problem solving system 100 according to the present invention may generate the solution to the test problem by synthesizing the core knowledge into the candidate components (S400).

Specifically, as illustrated in FIG. 12, the problem solving system 100 may specify the transformation relationship from the example input data to the example output data based on the core knowledge (S410), and generate the solution to the test problem by applying the previously specified transformation relationship from the hierarchical knowledge graph for the test problem to the specified candidate components (S420).

For example, the problem solving system 100 may specify, in the core knowledge, the relationship between the node (e.g., the second node and/or the third node) corresponding to the example input data and the node (e.g., the second node and/or the third node) corresponding to the example output data connected by the edge as the transformation relationship.

To this end, the problem solving system 100 may specify a command for transforming the node corresponding to the example input data to the node corresponding to the example output data based on the core knowledge, and the command may include a command for generating another node at an adjacent location based on a location of a specific node, a command for adjusting the location of the node, a command for changing the color of the node, etc.

Accordingly, the problem solving system 100 may generate the solution to the test problem by applying the previously specified transformation relationship to the candidate components.

For another example, the problem solving system 100 may generate the solution to the test problem by generating the node corresponding to the path according to the core knowledge from the candidate components based on the core knowledge specified in the form of the path based on the hierarchical knowledge graph of the plurality of example problems.

According to the configuration described above, the problem solving system 100 may generate the hierarchical knowledge graph having the hierarchical symbolic nodes from the abstraction and inference problems, specify the core knowledge based on the hierarchical knowledge graph of the example problem, and generate the solution to the test problem by applying the specified core knowledge to the hierarchical knowledge graph of the test problem, thereby establishing the problem solving process similar to that of the human and derive the accurate solutions to the abstraction and inference problems based on the established problem solving process.

In addition, the problem solving system 100 may solve the test problem based on the recurring pattern through the sequential observation of the plurality of example problems corresponding to the abstraction and inference problems, thereby deriving the accurate solution through the abductive reasoning for the abstraction and inference problems.

Furthermore, the problem solving system 100 according to the present invention may be implemented through the computing device described below and perform the data processing related to the problem solving method described above.

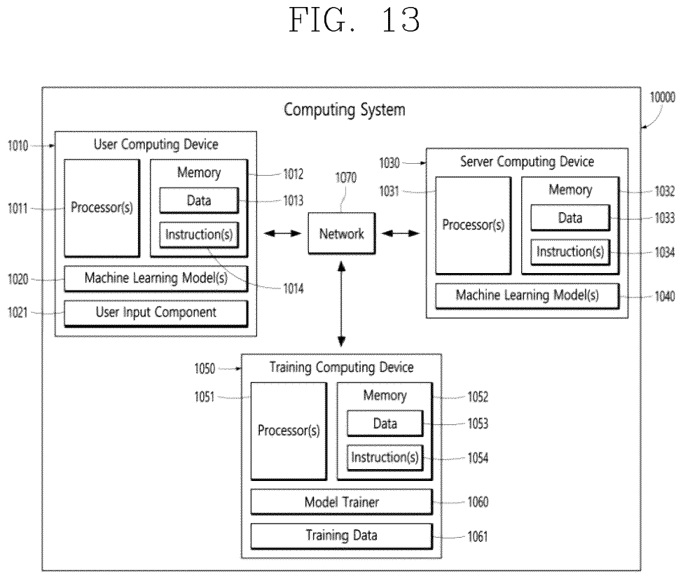

FIG. 13 illustrates an example block diagram of a computing system in which the present invention may be implemented.

Referring to FIG. 13, a computing system (10000) for performing a problem solving method based on abductive reasoning for abstraction and inference problems, according to an embodiment of the present invention, may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) that performs a problem solving method based on abductive reasoning for abstraction and inference problems may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network in a cloud environment.

Meanwhile, when the at least one computing device is used in at least one environment among a network environment and a cloud computing environment, the at least one computing device may be connected to at least one of a public network and a private network through a network interface or adapter. In one embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 13 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing a problem-solving method based on abductive reasoning for abstraction and inference problems according to the present invention may include at least one of a user computing device (1010), a training computing device (1050), and a server computing device (1030).

The user computing device (1010) according to the present invention may be understood as a computing device including at least one processor (1011) and memory (1012) for performing the problem solving method based on abductive reasoning for abstraction and inference problems. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for problem solving based on abductive reasoning for abstraction and inference problems.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In one embodiment, the user computing device (1010) may store one or more machine learning models (1020). For example, the user computing device (1010) may include various machine learning models such as multiple neural networks (e.g., deep neural networks) that perform problem solving based on abductive reasoning for abstraction and inference problems using example problems and test problems. These machine learning models may also include other types of models such as nonlinear models and/or linear models or may be a combination thereof.

According to an embodiment of the present invention, the user computing device (1010) may perform a problem solving method based on abductive reasoning for abstraction and inference problems by using a local and/or external machine learning model (1020). Alternatively, the user computing device (1010) may perform the problem solving method based on abductive reasoning for abstraction and inference problems by using a machine learning model (1040) provided by a server.

According to another embodiment of the present invention, a server computing device (1030) communicating with the user computing device (1010) may provide a solution to an abstraction and inference problem to the user computing device (1010) via an application and/or a web interface, in response to a request received from the user through the user computing device (1010).

According to yet another embodiment of the present invention, at least a portion of the user computing device (1010) and the server computing device (1030) may be cooperatively operated to perform a problem-solving method based on abductive reasoning for abstraction and inference problems, thereby providing a solution to the abstraction and inference problem to the user.

According to various embodiments of the present invention, the user computing device (1010) and/or the server computing device (1030) may train the machine learning models (1020, 1040) used in the problem solving method based on abductive reasoning for abstraction and inference problems through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for problem solving based on abductive reasoning for abstraction and inference problems.

In one embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations—such as model training, model reconstruction, model validation, and model testing—on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In one embodiment, training of the machine learning model may include a step of repeatedly inputting the training data (1061) based on epochs, and iteratively performing the machine learning model training process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

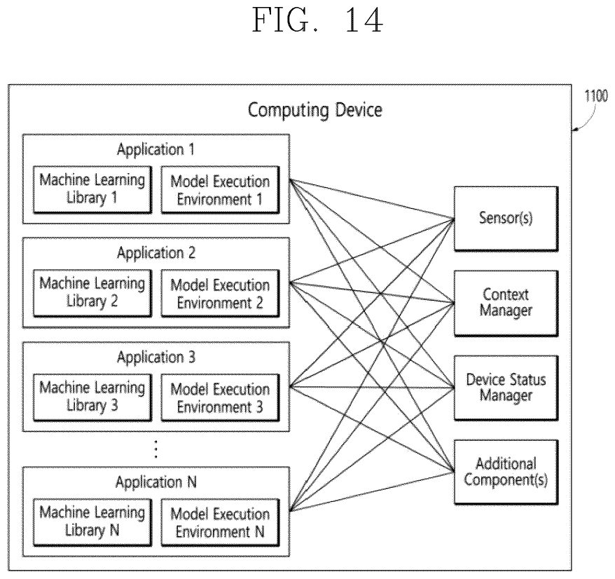

Meanwhile, FIG. 14 illustrates an example block diagram of a computing device (1100), which may be included in the user computing device (1010), the server computing device (1030), or the training computing device (1050), as one embodiment of the computing system (10000) in which the present invention may be implemented.

As shown in FIG. 14, the computing device (1100) may include at least one application (e.g., Application 1 to Application N), and each of the at least one application may include a machine learning library and a model execution environment for performing a problem solving method based on abductive reasoning for abstraction and inference problems using machine learning.

Each of the at least one application included in the computing device (1100) may communicate via an Application Programming Interface (API) with one or more components within the computing device (1100), such as sensors, a context manager, a device state manager, or additional components.

In one embodiment, the at least one application may interface with device components by, for example, receiving sensor data or state data via a public or dedicated API, or transmitting prediction results to an output device.

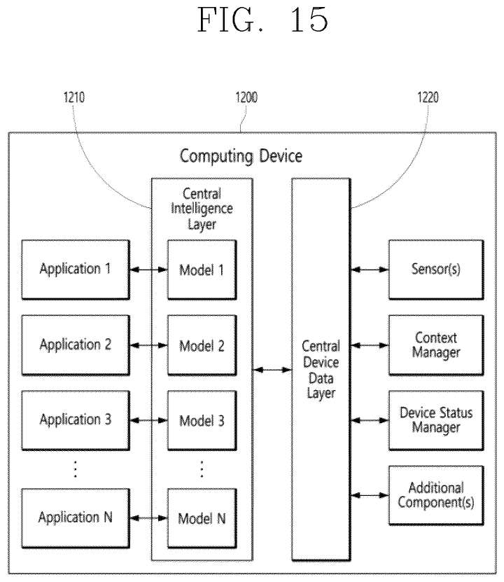

Meanwhile, FIG. 15 illustrates an example block diagram of a computing device (1200), which is one component of the computing system (10000) performing the problem solving method based on abductive reasoning for abstraction and inference problems according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In one embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store example problems and test problems included in the abstraction and inference problems within the computing device (1200) and provide them as input data required for problem solving based on abductive reasoning for abstraction and inference problems. Each device component (e.g., sensors, state managers, etc.) may communicate with the central device data layer (1220) via a private API or the like.

The technologies described in the present specification may be implemented in a single or multiple computing devices. The machine learning model for performing the problem solving method based on abductive reasoning for abstraction and inference problems may be executed sequentially or in parallel on a single component or across multiple distributed components. The data store, machine learning models, and applications may be distributed and operated locally or over a network, and such configurations may be flexibly applied to various system architectures.

In the above description, the problem solving system 100 of the present invention has been described as being implemented as a computing system, but the present invention is not limited thereto. For example, the functions of the neural network and/or the computing device may be distributed among a plurality of computing clusters.

In addition, the present invention described above may be implemented as a program that is executed by one or more processes in the electronic device and stored in the computer-readable recording medium.

Therefore, the present invention can be implemented as a computer-readable code or instruction in the medium in which the program is recorded. That is, various control methods according to the present invention may be provided in the form of an integrated or individual program.

Meanwhile, the computer-readable medium includes all types of recording devices in which data that can be read by the computer system is stored. An example of the computer-readable medium may include a hard disk drive (HDD), a solid state disk (SSD), a silicon disk drive (SDD), a ROM, a RAM, a CD-ROM, a magnetic tape, a floppy disk, an optical data storage, and the like.

Furthermore, the computer-readable medium may be a server or cloud storage that includes storage and that the electronic device may access through communication. In this case, the computer may download the program according to the present invention from the server or cloud storage through wired or wireless communication.

Furthermore, in the present invention, the computer described above is an electronic device equipped with a processor, that is, a central processing unit (CPU), and there is no particular limitation on its type.

Meanwhile, the above-described detailed description is to be interpreted as being illustrative rather than being restrictive in all aspects. The scope of the present invention is to be determined by reasonable interpretation of the claims, and all modifications within an equivalent range of the present invention fall in the scope of the present invention.

What is claimed is:

1. A problem solving method processed by a computing device, comprising:
confirming an example problem and a test problem included in an abstraction and inference problem;
generating a hierarchical knowledge graph having a plurality of layers by hierarchically analyzing the example problem from a pixel level to a problem level, and specifying core knowledge appearing in the example problem based on the hierarchical knowledge graph;
generating the hierarchical knowledge graph having the plurality of layers by hierarchically analyzing the test problem from the pixel level to the problem level, and specifying a candidate component corresponding to the core knowledge based on the hierarchical knowledge graph for the test problem; and
generating a solution to the test problem by synthesizing the core knowledge into the candidate component.

2. The problem solving method of claim 1, wherein, in the specifying of the core knowledge, the hierarchical knowledge graphs generated for each of the plurality of example problems included in the abstraction and inference problems are compared by layer, and one or more nodes having the same property are specified as the core knowledge.

3. The problem solving method of claim 1, wherein the generating of the solution includes:
specifying a transformation relationship from example input data to example output data included in the example problem based on the core knowledge; and
generating the solution to the test problem by applying the specified transformation relationship from the hierarchical knowledge graph for the test problem to the specified candidate component.

4. The problem solving method of claim 1, wherein the specifying of the core knowledge includes:
generating a first layer through analysis of the example problem in the pixel level;
generating a second layer by analyzing properties of a plurality of first nodes generated in the first layer according to an analysis result in the pixel level;
generating a third layer based on one or more second nodes generated in the second layer according to an analysis result of the properties; and
generating a fourth layer based on the third layer generated for example input data and example output data included in the example problem, respectively.

5. The problem solving method of claim 4, wherein the generating of the first layer includes:
generating, in the first layer, the plurality of first nodes in the pixel level for each of the example input data and the example output data;
comparing the properties of each of the plurality of first nodes in the example input data and the plurality of first nodes in the example output data; and
generating an edge connecting the first node in the example input data and the first node in the example output data based on the comparison result.

6. The problem solving method of claim 4, wherein the generating of the second layer includes:
specifying one or more first nodes having the same properties in each of the first layer for the example input data and the first layer for the example output data;
generating a second node including the one or more specified first nodes in the second layer;
comparing a second node in the example input data and a second node in the example output data; and
generating an edge connecting the second node in the example input data and the second node in the example output data based on the comparison result.

7. The problem solving method of claim 4, wherein the generating of the third layer includes:
specifying one or more second nodes generated for each of the second layer for the example input data and the second layer for the example output data; and
generating a third node including the one or more specified second nodes in the third layer.

8. The problem solving method of claim 4, wherein the generating of the fourth layer includes:
specifying a third node generated in each of the third layer for the example input data and the third layer for the example output data; and
generating a fourth node including the third node in the specified example input data and the third node in the example output data, in the fourth layer.

9. A problem solving system, comprising:
a storage unit storing an example problem and a test problem included in an abstraction and inference problem; and
a control unit analyzing the example problem and generating a solution corresponding to the test problem,
wherein the control unit generates a hierarchical knowledge graph having a plurality of layers by hierarchically analyzing the example problem from a pixel level to a problem level, specifies core knowledge appearing in the example problem based on the hierarchical knowledge graph, generates a hierarchical knowledge graph having a plurality of layers by hierarchically analyzing the test problem from the pixel level to the problem level, specifies a candidate component corresponding to the core knowledge based on the hierarchical knowledge graph for the test problem, and synthesizes the core knowledge into the candidate component to generate a solution to the test problem.

10. The problem solving system of claim 9,
wherein, in specifying the core knowledge, the control unit is configured to compare the hierarchical knowledge graphs generated for each of the plurality of example problems included in the abstraction and inference problems by layer, and to specify one or more nodes having the same property as the core knowledge.

11. The problem solving system of claim 9,
wherein the control unit is configured to generate the solution by:
specifying a transformation relationship from example input data to example output data included in the example problem based on the core knowledge; and
applying the specified transformation relationship from the hierarchical knowledge graph for the test problem to the specified candidate component to generate the solution to the test problem.

12. The problem solving system of claim 9,
wherein, in specifying the core knowledge, the control unit is configured to:
generate a first layer through analysis of the example problem in the pixel level;
generate a second layer by analyzing properties of a plurality of first nodes generated in the first layer according to an analysis result in the pixel level;
generate a third layer based on one or more second nodes generated in the second layer according to an analysis result of the properties; and
generate a fourth layer based on the third layer generated for example input data and example output data included in the example problem, respectively.

13. The problem solving system of claim 12,
wherein the control unit is configured to generate the first layer by:
generating, in the first layer, the plurality of first nodes in the pixel level for each of the example input data and the example output data;
comparing the properties of each of the plurality of first nodes in the example input data and the plurality of first nodes in the example output data; and
generating an edge connecting the first node in the example input data and the first node in the example output data based on the comparison result.

14. The problem solving system of claim 12,
wherein the control unit is configured to generate the second layer by:
specifying one or more first nodes having the same properties in each of the first layer for the example input data and the first layer for the example output data;
generating a second node including the one or more specified first nodes in the second layer;
comparing a second node in the example input data and a second node in the example output data; and
generating an edge connecting the second node in the example input data and the second node in the example output data based on the comparison result.

15. A program stored in a non-transitory computer-readable storage medium, executed by one or more processes in an electronic device, wherein the program includes instructions to perform:
confirming an example problem and a test problem included in an abstraction and inference problem;
generating a hierarchical knowledge graph having a plurality of layers by hierarchically analyzing the example problem from a pixel level to a problem level, and specifying core knowledge appearing in the example problem based on the hierarchical knowledge graph;
generating the hierarchical knowledge graph having the plurality of layers by hierarchically analyzing the test problem from the pixel level to the problem level, and specifying a candidate component corresponding to the core knowledge based on the hierarchical knowledge graph for the test problem; and
generating a solution to the test problem by synthesizing the core knowledge into the candidate component.

16. The non-transitory computer-readable storage medium of claim 15,
wherein the instructions, when executed by one or more processors, cause the one or more processors, in specifying the core knowledge, to compare the hierarchical knowledge graphs generated for each of the plurality of example problems included in the abstraction and inference problems by layer, and to specify one or more nodes having the same property as the core knowledge.

17. The non-transitory computer-readable storage medium of claim 15,
wherein the instructions, when executed by one or more processors, cause the one or more processors to generate the solution by:
specifying a transformation relationship from example input data to example output data included in the example problem based on the core knowledge; and
applying the specified transformation relationship from the hierarchical knowledge graph for the test problem to the specified candidate component to generate the solution to the test problem.

18. The non-transitory computer-readable storage medium of claim 15,
wherein the instructions, when executed by one or more processors, cause the one or more processors, in specifying the core knowledge, to:
generate a first layer through analysis of the example problem in the pixel level;
generate a second layer by analyzing properties of a plurality of first nodes generated in the first layer according to an analysis result in the pixel level;
generate a third layer based on one or more second nodes generated in the second layer according to an analysis result of the properties; and
generate a fourth layer based on the third layer generated for example input data and example output data included in the example problem, respectively.

19. The non-transitory computer-readable storage medium of claim 18,
wherein the instructions, when executed by one or more processors, cause the one or more processors to generate the first layer by:
generating, in the first layer, the plurality of first nodes in the pixel level for each of the example input data and the example output data;
comparing the properties of each of the plurality of first nodes in the example input data and the plurality of first nodes in the example output data; and
generating an edge connecting the first node in the example input data and the first node in the example output data based on the comparison result.

20. The non-transitory computer-readable storage medium of claim 18,
wherein the instructions, when executed by one or more processors, cause the one or more processors to generate the second layer by:
specifying one or more first nodes having the same properties in each of the first layer for the example input data and the first layer for the example output data;
generating a second node including the one or more specified first nodes in the second layer;
comparing a second node in the example input data and a second node in the example output data; and
generating an edge connecting the second node in the example input data and the second node in the example output data based on the comparison result.
